(19) United States
(12) Patent Application Publication
(10) Pub. No.: US 2014/0165746 A1
(43) Pub. Date: Jun. 19, 2014

(54) Scent Collection and Retention

(71) Applicants: Coby Webb, Cherry Valley, CA (US); Travis Shows, Lake Elsinore, CA (US)

(72) Inventors: Coby Webb, Cherry Valley, CA (US); Travis Shows, Lake Elsinore, CA (US)

(21) Appl. No.: 13/920,839

(22) Filed: Jun. 18, 2013

Related U.S. Application Data
(60) Provisional application No. 61/739,419, filed on Dec. 19, 2012.

(51) Int. Cl. G01N 1/22

(52) U.S. Cl. CPC G01N 1/22
USPC 73/864.51

(57) ABSTRACT

A scent storage element is described. The scent storage element includes: a scent-retaining portion formed by at least one sealed section along an edge of the scent storage element; a re-sealable feature along an edge of the scent-retaining portion; and a tamper-proof element adapted to provide an indication as to whether the re-sealable feature has been opened after the tamper-proof element has been secured. A scent collection and storage kit includes: a case; a scent storage element; a scent retention element adapted to fit within the scent storage element; and usage instructions. A scent collection kit includes: a scent retention element; and a scent storage element adapted to house the scent retention element.

### CROSS-REFERENCE TO RELATED APPLICATIONS

This application claims priority to U.S. Provisional Patent Application Ser. No. 61/739,419, filed on Dec. 19, 2012.

### BACKGROUND

Many individuals and/or items may go missing at some point. Such missing individuals and/or items may be tracked by scent (e.g., using a trained Bloodhound). However, in many cases, authorities may not be able to obtain a useful scent sample associated with the missing individual or item, due to various reasons (e.g., a child's scent on a particular item may be contaminated by various other scents such as the scents of siblings that may use or contact the item, the scents of parents that may use, contact, or clean the item, scents of perfumes, cosmetics or cleaning products used by the individual (or associated with an item), etc.).

Thus, there exists a need for a way to collect a scent sample that is associated with only one individual or item and to store the collected sample in a secure way such that the sample may not be contaminated by other scents (and/or otherwise tampered with between collection and use).

### BRIEF SUMMARY

Some embodiments provide a bag to hold a scent for the purpose of tracking, with a trained dog (or other appropriate animal), an individual or item. Such tracking may occur at a later time than the collection of the scent. Trained tracking dogs, such as Bloodhounds, may be utilized in search and rescue operations along with law enforcement personnel, for the purpose of locating missing and outstanding persons. Before a dog team can begin looking for a person, a “scent article” belonging to a specific individual to be tracked is required. Such an article may be, for instance, a shoe track (or footprint), clothing or other personnel item belonging to the specific individual, etc.

A problem commonly arises where a handler does not have confirmation that the scent item belongs to the person (or item) being tracked. For example, a footprint may belong to a previous (or subsequent) hiker or another individual trying to locate the missing person. As another example, clothing may be difficult to use as a scent item for a missing child because the parents may wash and fold the clothing. Subsequently, a tracking dog may not be able to discern which person to track. Such scent transfer may be referred to as “contamination”.

Gauze pads may be used by law enforcement personnel to collect scent from suspects. Law enforcement and/or search and rescue personnel may lay a gauze pad on an article that a suspect (or missing person, item, etc.) has handled or come in contact with in order to collect the scent. The handler may then present the gauze pad to a trained dog in order to track the suspect.

The scent collection system of some embodiments may allow parents, families, law enforcement officials, and/or other appropriate users (e.g., staff at assisted living facilities, school administrators, etc.) to have this resource readily available before an individual goes missing. Non-professional (and/or inexperienced) users may be able to conform to proper scent collecting techniques and effectively capture a scent using the system of some embodiments.

Having a scent storage element available for the general public provides an improved way to find lost individuals in a timely manner. A properly collected scent pad may be stored for over a year (and potentially up to three or five years) and still allow a tracking dog to trail the individual or item associated with the stored scent. Thus, various users may be able to collect and store samples from one or more individuals before any of the individuals goes missing. Various individuals may have conditions (e.g., Alzheimer's disease, epilepsy, etc.) that make the individuals more likely to go missing and thus may be candidates for collection of scent samples by an institution or facility to allow for tracking of such individuals.

Various types of dogs may be used in dog scent procedures (e.g., a tracking dog, a trailing dog, and a scent-identification dog). Tracking dogs are trained to locate the track of a sought-after person without receiving an initial scent. Trailing dogs are given an initial scent and asked to follow that scent until the scent trail ends. Scent-identification (or air-scent) dogs receive an initial scent (often from an object found at a crime scene), and are asked to match this initial scent to one of a selection of scents later presented to the animal. These three areas of canine specialization also correspond to a particular source to which the canine is oriented: ground scent, air-scent, or a combination of the ground and the air. While tracking and trailing dogs are most effectively used to track suspects or victims from the location of the crime scene, air-scent dogs are most effective in locating a person in a particular area identified as a known search area.

The most common dog scent procedure(s) presented as evidence at trial is use of tracking and/or trailing evidence. Another common scent procedure is scent lineups. Dog scent lineups are conducted using either human lineups or inanimate objects. In a scent lineup a dog matches a particular scent to either a person or an object. The dog detects “residual scent” which, for humans, is often the product of perspiration generated from fear, stress, or physical exertion. Scent preservation is an important aspect of such evidentiary uses.

The creation of a scent lineup begins when a scent is first collected at a crime scene. The object holding the scent is then placed in an airtight container where the scent can be preserved for an appropriate length of time (e.g., up to three years). The scent lineup may include a number of stainless steel pipes that have been scented by a suspect and typically five other persons. The canine may sniff the original scent evidence and then identify the matching scent located on one of the steel pipes.

The reliability of a scent-identification lineup may be affected by various factors such as the method of scent collection, the method of scent preservation, the error rate associated with the particular collections and/or preservation procedures, etc.

One exemplary embodiment of the invention provides a scent storage element that includes: a scent-retaining portion formed by at least one sealed section along an edge of the scent storage element; a re-sealable feature along an edge of the scent-retaining portion; and a tamper-proof element adapted to provide an indication as to whether the re-sealable feature has been opened after the tamper-proof element has been secured.

A second exemplary embodiment of the invention provides a scent collection and storage kit that includes: a case; a scent storage element; a scent retention element adapted to fit within the scent storage element; and usage instructions.

A third exemplary embodiment of the invention provides a scent collection kit that includes: a scent retention element; and a scent storage element adapted to house the scent retention element.

The preceding Summary is intended to serve as a brief introduction to some embodiments of the invention. It is not meant to be an introduction or overview of all inventive subject matter disclosed in this document. The Detailed Description that follows and the Drawings (or “Figures” or “FIGS.”) that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matter is not to be limited by the illustrative details in the Summary, Detailed Description and the Drawings, but rather is to be defined by the appended claims, because the claimed subject matter may be embodied in other specific forms without departing from the spirit of the invention.

### BRIEF DESCRIPTION OF THE DRAWINGS

The novel features of the invention are set forth in the appended claims. However, for purpose of explanation, several embodiments of the invention are set forth in the following drawings.

FIG. 1 illustrates a front view of a scent storage element according to an exemplary embodiment of the invention;

FIG. 2 illustrates several views of a case for a scent collection kit according to an exemplary embodiment of the invention;

FIG. 3 illustrates a front view and a side view of the opened case of FIG. 2;

FIG. 4 illustrates a front view of scent collection instructions included in some embodiments;

FIG. 5 illustrates a flow chart of a conceptual process for collecting a scent using the scent storage element of FIG. 1;

FIG. 6 illustrates a flow chart of a conceptual process for collecting and retaining a scent using the scent collection kit of some embodiments;

FIG. 7 illustrates a flow chart of a conceptual process used by some embodiments to notify a user that a stored scent should be updated;

FIG. 8 illustrates a flow chart of a conceptual process used by some embodiments to retrieve a previously stored scent; and

FIG. 9 conceptually illustrates a schematic block diagram of a computer system with which some embodiments of the invention may be implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Several more detailed embodiments of the invention are described in the sections below. Section I provides a conceptual description of the scent storage element provided by some embodiments. Section II then describes a scent collection kit provided by some embodiments. Next, Section III describes various processes that may be used by some embodiments to manage scent collection. Lastly, Section IV describes a computer system, which implements some of the embodiments of the invention.

### I. Scent Storage Element

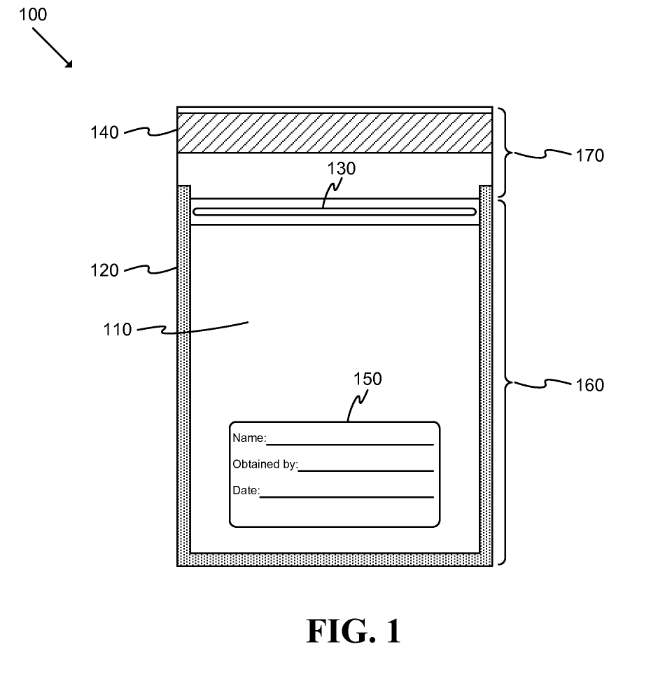

FIG. 1 illustrates a front view of a scent storage element 100 according to an exemplary embodiment the invention. Specifically, this figure shows a sealable bag that may be provided by some embodiments. Such a bag may be used to hold a scent sample and may be used to track an individual (or item) at a later time.

As shown, the scent storage element may include an air-tight (or nearly air-tight) scent-retaining portion 110 that may be defined by a heat seal 120 along an external edge of the portion and a sealable (or re-sealable) feature 130 (e.g., a zipper-type closure, a double-zipper type seal, etc.) such that the scent-retaining portion 110 may be easily accessed. In some embodiments, the scent-retaining portion 110 is generally rectangular in shape and may be formed by one or more sections of appropriate materials (e.g., food-grade plastic, polymer, etc.) having a heat seal (and/or other appropriate type of seal) along three sides of the external edge and a re-sealable feature on the fourth side of the rectangle. The storage element 100 may be made using material of appropriate thickness (e.g., ten thousandths of an inch) such that appropriate protection from elements outside the storage element is provided and such that scent associated with the stored sample is not dissipated to the exterior of the storage element (or is dissipated at a slow enough rate that the stored sample is viable for an appropriate length of time).

The storage element 100 may also include a tamper-proof feature 140 (e.g. a flap with an adhesive strip) that may be used to secure the sealable feature 130 such that the sealable feature may not be opened without exhibiting signs that a scent sample may have been contaminated since being place in the storage element 100. Different embodiments may include various different tamper-proof features (e.g., paper tape may be placed across a seal of the element such that the tape will indicated if the seal is opened).

The storage element 100 may include various labels, markers, graphics, etc. 150, that may indicate various properties of the storage element 100 and may include space for a user to enter information regarding any scent sample stored in the element 100 (e.g., name of the person associated with the sample, date the sample was acquired, name of the person who collected the sample, etc.). The label 150 may include various entry regions, each region associated with a particular attribute associated with the sample.

As shown in FIG. 1, the scent-retaining portion 110 may span a first region 160 along an edge of the storage element 100 while the tamper-proof feature 140 may span a second region 170 along the edge of the storage element.

During use, an appropriate scent retention element (e.g., a four inch by four inch square gauze pad) may be used to collect a scent sample and may be placed in the storage element 100 through the open seal 130. Some embodiments may provide instructions as to scent collection and placement in the storage element. The storage element may be sized to allow a user to easily slide the gauze pad (or other appropriate scent collection and retention element) into the scent-retaining portion 110 without placing a hand inside the storage element 100, thus reducing the possibility of contaminating the scent-retaining portion 110. Once the scent retention element has been placed in the storage element 100, the seal 130 may be closed.

The tamper-proof protection feature 140 may include tape (or other appropriate adhesive) placed along a flap that extends past the sealable feature 130. The adhesive may have an associated adhesive cover and the adhesive may be exposed (e.g., by pulling off a paper strip or other appropriate adhesive cover) after the gauze pad has been placed inside the scent-retaining portion 110 and the seal 130 has been closed. The flap 170 may then be folded over the zipper-type seal and secured to an exterior surface of the scent storage element 100 using the exposed adhesive. The tamper-proof feature 140 helps ensure that the intended contents of the bag are not contaminated.

One of ordinary skill in the art will recognize that the scent storage element 100 may be implemented in various different ways without departing from the spirit of the invention. For instance, different embodiments may include differently sized and/or shaped elements with various different types of seals (e.g., a round storage element may include a cylindrically shaped cavity and a screw-on top that forms a seal using a gasket). As another example, different embodiments may use different types, sizes, and/or shapes of scent retention elements.

In addition, one of ordinary skill in the art will recognize that the various Figures described herein are conceptual in nature and not intended to define actual sizes, ratios, included features, etc.

### II. Scent Collection Kit

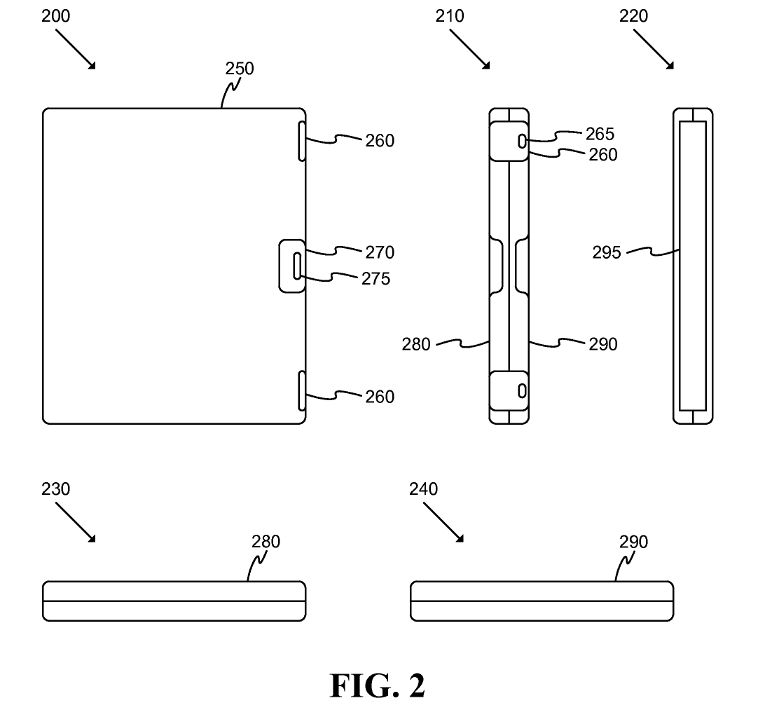

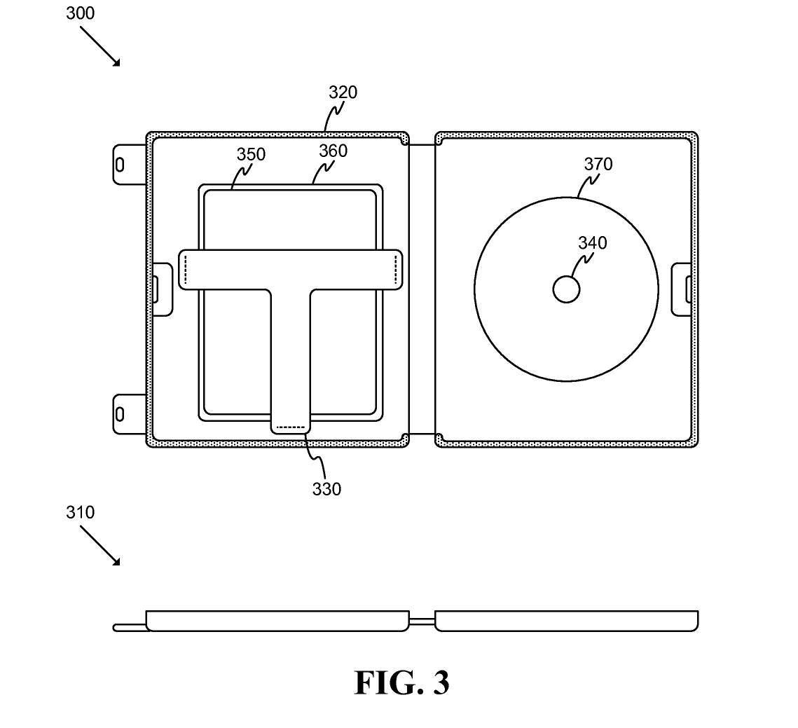

FIG. 2 illustrates a front view 200, a side view 210, an alternative side view 220, a bottom view 230 and a top view 240 of a case 250 for a scent collection kit according to an exemplary embodiment of the invention. Specifically, this figure shows example exterior features of the case. The interior features and/or any separate elements included with the kit will be described below in reference to FIG. 3.

As shown in FIG. 2, the case 250 may include one or more latches (or “clasps”) 260, each with a through-tab 265, a tamper-proof element having a recessed portion 270 with a through-hole 275, a front portion 280, a rear portion 290, and one or more hinges 295. In this example, the case 250 is generally rectangular-shaped and may open or close in a book-like fashion.

The latches 260, in conjunction with the through-tabs 265 may allow the case 250 to be securely closed, when desired. Different embodiments may use different elements and/or types of elements to securely close the case (e.g., hook-and-loop fasteners, adhesive elements, etc.).

The recessed portion 270 and through-hole 275 may allow the case to be securely closed in a manner that indicates whether the case has been opened afterward (and, thus, whether the contents of the case may be contaminated). Some embodiments may utilize a component such as a cable tie to implement the tamper-proof element, whereby the cable tie may be passed through the through-hole 275 and tightened around a region of the recessed portion 270. Such a cable tie (or other appropriate component such as tape, adhesive flap, etc.) may include an identifying element (e.g., a unique ID number or code, a bar code or other graphically-represented data, etc.) that may be used to further enhance the tamper-proof features of the case 250 such that the cable tie (or other element) may not be easily replaced if removed after being secured to the case. In some embodiments, the identifying element may include a serialized number or code such that each kit, system, or element is associated with a unique code.

The hinge 295 may allow the front 280 and rear 290 sections of the case 250 to move about one or more axes or rotation defined by the hinge 295. Different embodiments may implement the hinge(s) in various different ways, as appropriate. Alternatively, some cases may be opened and/or closed using other elements. For instance, a round case may include a screw-on top, a case may include front and rear portions that may be connected using a set of latches or other appropriate elements, etc.

The case may be sized such that various components may be included in the kit associated with the case (e.g., a scent storage element, a scent retention element, instructions, etc.), such that a scent storage element (and associated scent retention element) may be stored in the case, and/or based on other appropriate factors (e.g., intended use of the kit, desired storage location, etc.). The case may be made of various appropriate materials (e.g., plastic, metal, etc.) that may be of appropriate thickness to provide a secure case that may not be opened without showing signs of tampering.

During use, a typical user may receive a case 250 including a scent collection kit. The user may open the case (e.g., by opening one or more latches) to retrieve the contents of the kit. After collecting a sample, the user may close the case (e.g., by closing one or more latches) and activate any tamper-proof elements (e.g., by securing a cable tie to the case). In some cases, the secured case may be cataloged and stored by another party (e.g., the party providing the kit).

One of ordinary skill in the art will recognize that the case 250 may be implemented in various different ways without departing from the spirit of the invention. For instance, the case may be shaped or sized in various different ways. As another example, the case may be constructed using various different materials, components, etc.

FIG. 3 illustrates a front view 300 and a side view 310 of the opened case 250. As shown, the case may include structural support elements 320 along the edge of front 280 and rear 290 sections of the case 250, a holding element 330, a second holding element 340 and various components 350-370 included in the kit of some embodiments.

The structural support elements 320 may be of appropriate thickness such that the case 250 may have sufficient structural rigidity to protect the elements stored in the case and such that the case may not be opened without such tampering being indicated by the tamper-proof elements of some embodiments once those elements have been secured.

The holding element 330 may be made of various appropriate materials (e.g., polypropylene or other thermoplastic polymer, spandex, latex, plastic, etc.) and may be configured such that items secured by the holding element may be removed, used, and then replaced and stored. The holding element may secure kit components such as literature 350 (e.g., usage instructions, registration forms, etc.), a scent storage element 360 (e.g., scent storage element 100 described above), a scent collection element, not shown (e.g., a gauze pad), and/or other appropriate elements.

The second holding element 340 may be used to secure a disc 370 (e.g., a DVD, Blu-ray disc, CD, etc.) and/or other appropriate data storage element(s). Alternatively or conjunctively, users may be directed to a URL or other online resource that may include instructions, registration forms, downloadable applications, cloud-based applications, etc.

During use, a user may receive a kit (e.g., by purchasing a kit, receiving the kit from an establishment associated with the user, etc.). The user may then open the case housing the kit to retrieve use instructions, scent collection and storage elements, and/or other kit components. The user may then collect and store a scent by following the kit instructions before storing the collected scent in the case and securing any tamper-proof elements. In some embodiments, a scent may be sampled by applying a gauze pad (or other appropriate scent retention element) to a person for five minutes. The user may then store the case in an appropriate location or provide the kit to another party for storage.

Although the kit has been described with reference to various specific details, one of ordinary skill in the art will recognize that the kit may be implemented in various different ways without departing from the spirit of the invention. For instance, different embodiments may include various different components (e.g., uncolored non-latex gloves or other appropriate handling elements that are odorless or do not have any odor that may interfere with tracking) As another example, such a kit may be provided as separate elements without a case.

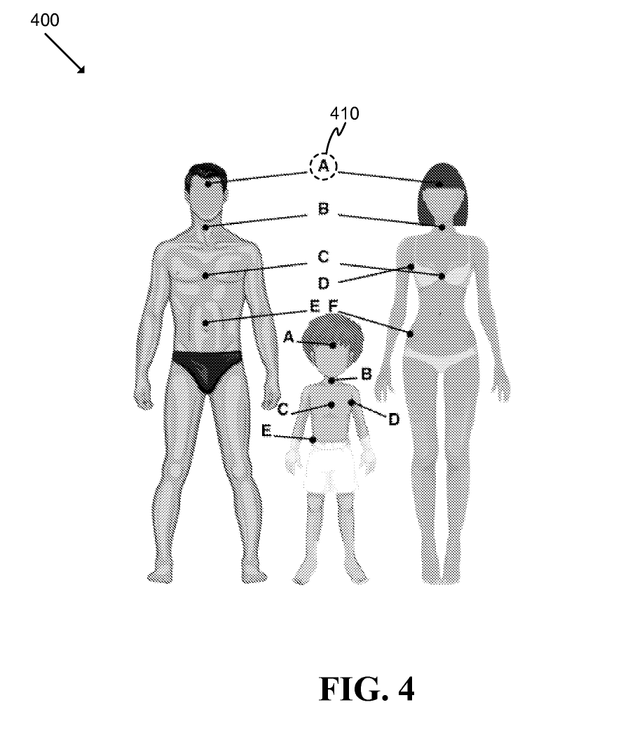

FIG. 4 illustrates a front view of scent collection instructions 400 included in some embodiments. As shown, such instructions may include references 410 to various scent-collection regions associated with a subject from whom the scent is to be collected. Such scent collection regions may be associated with regions that provide appropriate scents for tracking (e.g., a scent that is strong enough to be detected by a tracking animal such as a Bloodhound but not so strong as to overwhelm the animal). In addition, different regions may be specified depending on the usage scenario. For example, if a school is collecting samples from students or a care facility is collecting samples from patients, the sample may be collected from a physical region that is accessible without removing clothes, whereas a sample to be collected within a family may be collected from more private physical region.

One of ordinary skill in the art will recognize that the instruction 400 are provided for example purposes only and different embodiments may implement such instructions in various different ways. For instance, some embodiments may include only text-based instructions. As another example, some embodiments may include combinations of graphics and text. As another example, some embodiments may not include instructions at all (such as kits that may be routinely used by law enforcement personnel or other professionals that may receive training or instructions through other avenues).

### III. Methods of Operation

The various process described below may be implemented in various different ways. In any case, each process may be at least partially implemented as an automated process that includes operations performed by one or more devices (e.g., computing devices, manufacturing devices, etc.).

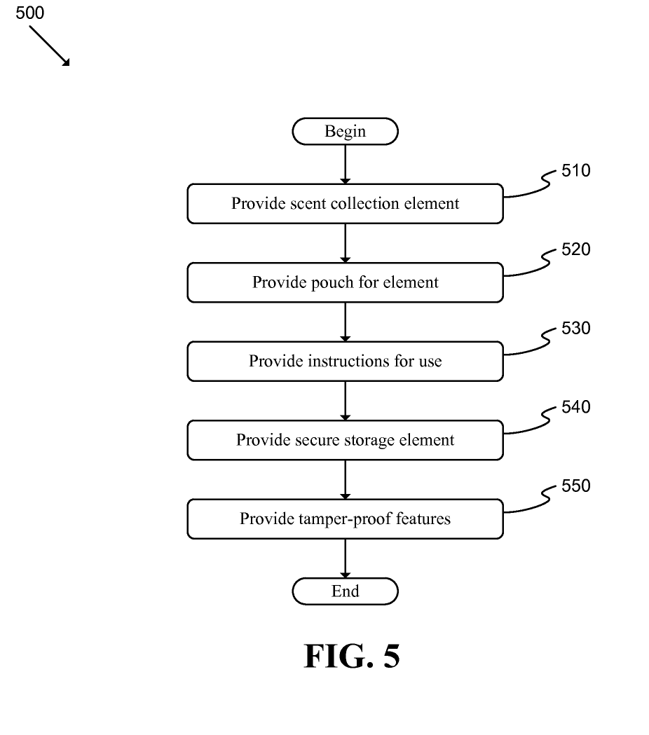

FIG. 5 illustrates a flow chart of a conceptual process 500 for collecting a scent using the scent storage element 100. Such a process 500 may begin, for instance, when a manufacturer generates a kit.

As shown, the process may provide (at 510) a scent collection element. Such a scent collection element may be, for instance, a four-inch by four-inch gauze pad. Next, the process may provide (at 520) a pouch for the collection element. Such a pouch may be, for instance, a sealable plastic bag as described above in reference to scent storage element 100.

The process may then provide (at 530) instructions for use. Such instructions may include instructions for collecting a scent, storing the collected scent, etc. Next, the process may provide (at 540) a secure storage element (e.g., scent storage element 100). The process may also provide (at 550) tamper-proof features associated with the scent storage element (and/or other appropriate components such as a case for a collection kit) and then may end.

One of ordinary skill in the art will recognize that process 500 is conceptual and may be implemented in various different ways without departing from the spirit of the invention. For instance, the process may be divided into multiple sub-processes or may be included as a portion of a larger macro-process. As another example, various operations may be omitted, included, and/or be performed in various different orders than shown.

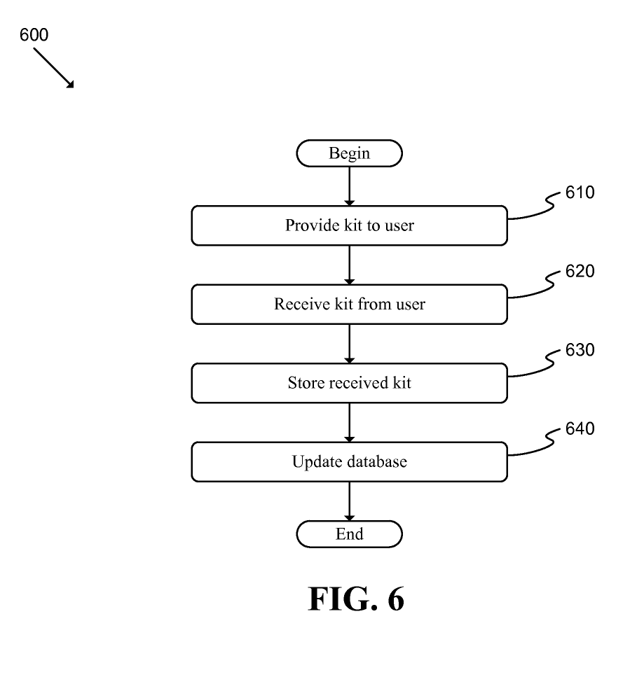

FIG. 6 illustrates a flow chart of a conceptual process 600 for collecting and retaining a scent using the scent collection kit of some embodiments. Such a process may begin, for instance, when a kit has been assembled by a manufacturer or other provider.

As shown, process 600 may provide (at 610) a kit to a user. The kit may be provided in various appropriate ways (e.g., offered for sale, given to a set of users based on their association with some entity, etc.). The process may then receive (at 620) the completed kit from the user. The kit may be received in various ways (e.g., a user may mail or otherwise send the kit, the user may deliver the kit to an establishment, etc.).

Next, the process may store (at 630) the received kit and update (at 840) a database and then may end. As described above, in some embodiments each kit will have a unique identifier (and/or may be identified in other ways such as name and address of the user, name and address of an institution, etc.), which may allow the kit to be stored such that the kit is able to be retrieved if needed. The database may include information associated with the kit (e.g., identifier, user information, institution information, storage location, authorized parties, etc.).

One of ordinary skill in the art will recognize that process 600 is conceptual and may be implemented in various different ways without departing from the spirit of the invention. For instance, the process may be divided into multiple sub-processes or may be included as a portion of a larger macro-process. As another example, various operations may be omitted, included, and/or be performed in various different orders than shown.

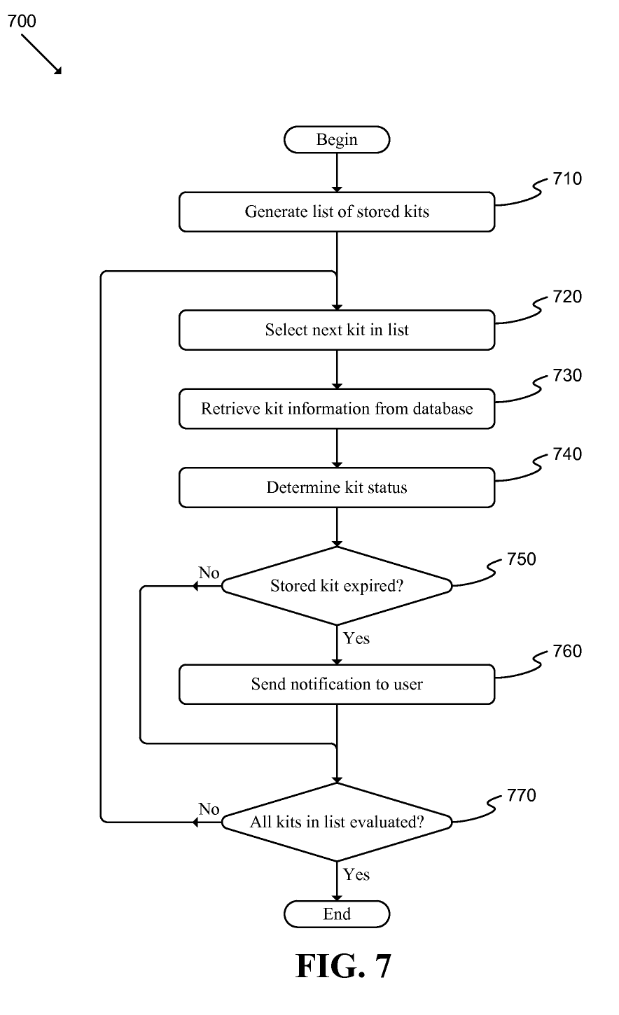

FIG. 7 illustrates a flow chart of a conceptual process 700 used by some embodiments to notify a user that a stored scent should be updated. Such a process may be being, for instance, when a kit provider requests a review of currently stored kits. The process may access one or more databases (e.g., the database described above in reference to process 600) and/or other elements, as appropriate.

Process 700 may generate (at 710) a list of stored kits. Such a list may be generated in various appropriate ways (e.g., by retrieving a list of kits from a database and evaluating a flag indicating that a kit has been received from a user and stored). Next, the process may select (at 720) the next kit in the list (the list may be ordered in various appropriate ways, such as by kit ID, by date of submission, etc.).

The process may then retrieve (at 730) information regarding the kit from the database. Such information may include any information associated with the kit (e.g., ID, user information, sample information, etc.). The process may then determine (at 740) the kit status (e.g., by determining whether the user is still active, by determining whether a user has asked to be notified of changes in status, etc.).

Next, the process may determine (at 750) whether the stored kit is expired. Such a determination may be made, for example, by comparing the date a kit was stored to an evaluation criteria (e.g., that a kit should be updated every year, every three years, every five years, etc.). If the process determines (at 750) that the kit has expired, the process may then send (at 760) a notification to the user. Such a notification may be sent, for example, via email, through a text message, by postal mail, by telephone, and/or other appropriate ways.

If the process determines (at 750) that the kit has not expired, or after sending (at 760) the notification, the process may then determine (at 770) whether all kits in the list have been evaluated. If the process determines that all kits have not been evaluated, the process may repeat operations 720-770 until the process determines (at 770) that all kits in the list have been evaluated, at which point the process may end.

One of ordinary skill in the art will recognize that process 700 is conceptual and may be implemented in various different ways without departing from the spirit of the invention. For instance, the process may be divided into multiple sub-processes or may be included as a portion of a larger macro-process. As another example, various operations may be omitted, included, and/or be performed in various different orders than shown.

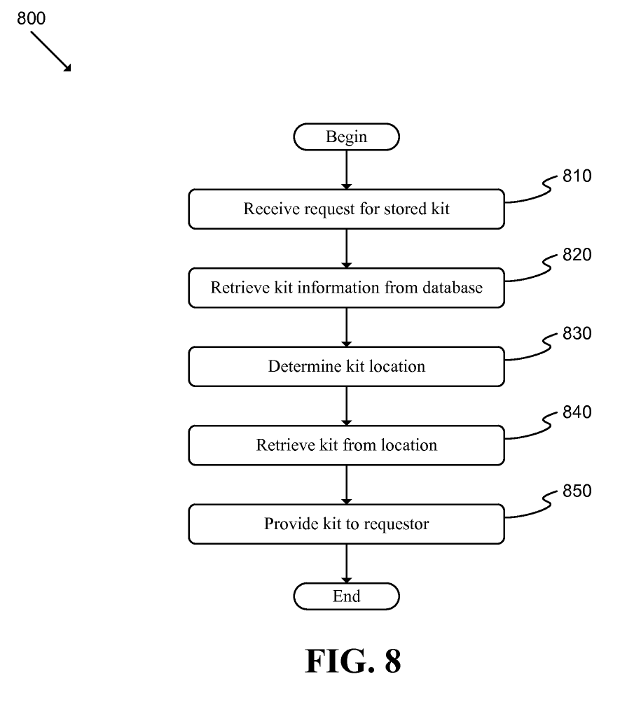

FIG. 8 illustrates a flow chart of a conceptual process 800 used by some embodiments to retrieve a previously stored scent. Such a process may begin, for instance, when a user (or other appropriate party, such as law enforcement personnel) determines that a person or item associated with a stored scent has gone missing.

As shown, the process may receive (at 810) a request for a stored kit. Such a request may be made in various appropriate ways (e.g., via a web portal, email, telephone, etc.). In some embodiments, such a request may be authenticated in various appropriate ways before proceeding (e.g., a user may enter a username and password to enter a web portal provided by the storage entity, identification credentials may be presented in person, etc.).

Next, the process may retrieve (at 820) kit information from a database. The process may then determine (at 830) the kit location (e.g., the kit may be associated with a warehouse location specified by an aisle, shelf, section, etc.). The process may then retrieve (at 840) the kit from the location and provide (at 850) the kit to the user.

One of ordinary skill in the art will recognize that process 800 is conceptual and may be implemented in various different ways without departing from the spirit of the invention. For instance, the process may be divided into multiple sub-processes or may be included as a portion of a larger macro-process. As another example, various operations may be omitted, included, and/or be performed in various different orders than shown.

### IV. Computer System

Many of the processes and modules described above may be implemented as software processes that are specified as at least one set of instructions recorded on a non-transitory storage medium. When these instructions are executed by one or more computational element(s) (e.g., microprocessors, microcontrollers, Digital Signal Processors (“DSP”), Application-Specific ICs (“ASIC”), Field Programmable Gate Arrays (“FPGA”), etc.) the instructions cause the computational element(s) to perform actions specified in the instructions.

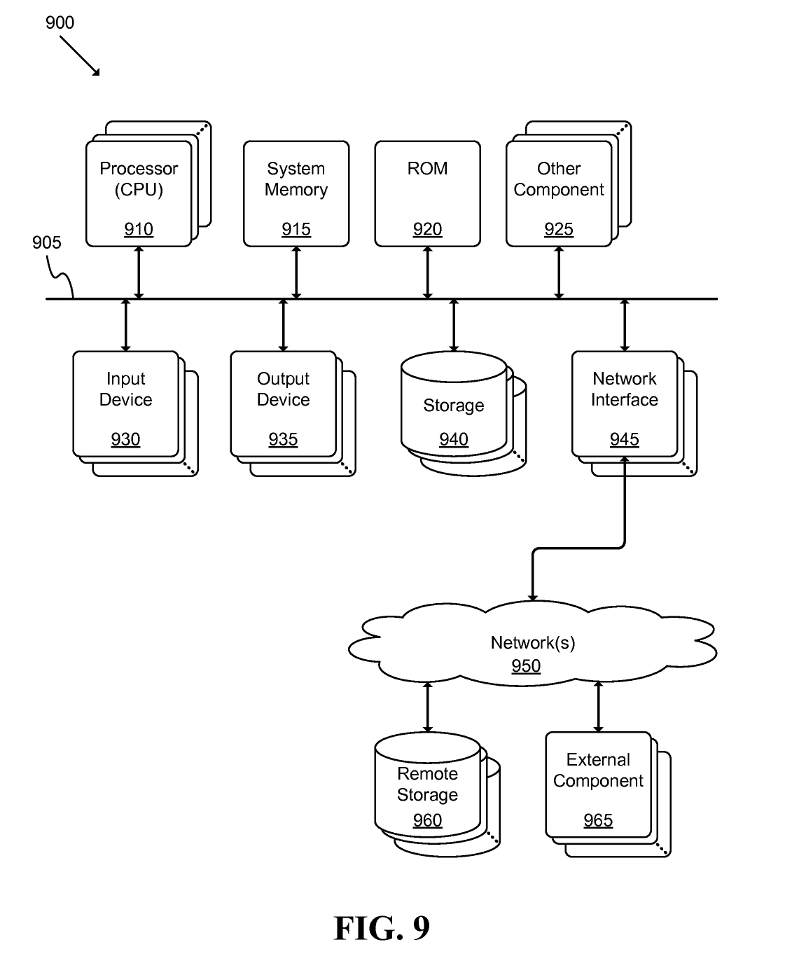

FIG. 9 conceptually illustrates a schematic block diagram of a computer system 900 with which some embodiments of the invention may be implemented. For example, the processes described in reference to FIGS. 5-8 may be at least partially implemented using sets of instructions that are executed using computer system 900.

Computer system 900 may be implemented using various appropriate devices. For instance, the computer system may be implemented using one or more personal computers (“PC”), servers, mobile devices (e.g., a Smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

Computer system 900 may include a bus 905, at least one processing element 910, a system memory 915, a read-only memory (“ROM”) 920, other components (e.g., a graphics processing unit) 925, input devices 930, output devices 935, permanent storage devices 940, and/or network interfaces 945. The components of computer system 900 may be electronic devices that automatically perform operations based on digital and/or analog input signals.

Bus 905 represents all communication pathways among the elements of computer system 900. Such pathways may include wired, wireless, optical, and/or other appropriate communication pathways. For example, input devices 930 and/or output devices 935 may be coupled to the system 900 using a wireless connection protocol or system. The processor 910 may, in order to execute the processes of some embodiments, retrieve instructions to execute and data to process from components such as system memory 915, ROM 920, and permanent storage device 940. Such instructions and data may be passed over bus 905.

ROM 920 may store static data and instructions that may be used by processor 910 and/or other elements of the computer system. Permanent storage device 940 may be a read-and-write memory device. This device may be a non-volatile memory unit that stores instructions and data even when computer system 900 is off or unpowered. Permanent storage device 940 may include a mass-storage device (such as a magnetic or optical disk and its corresponding disk drive).

Computer system 900 may use a removable storage device and/or a remote storage device as the permanent storage device. System memory 915 may be a volatile read-and-write memory, such as a random access memory (“RAM”). The system memory may store some of the instructions and data that the processor uses at runtime. The sets of instructions and/or data used to implement some embodiments may be stored in the system memory 915, the permanent storage device 940, and/or the read-only memory 920. Other components 925 may perform various other functions.

Input devices 930 may enable a user to communicate information to the computer system and/or manipulate various operations of the system. The input devices may include keyboards, cursor control devices, audio input devices and/or video input devices. Output devices 935 may include printers, displays, and/or audio devices. Some or all of the input and/or output devices may be wirelessly or optically connected to the computer system.

Finally, as shown in FIG. 9, computer system 900 may be coupled to a network 950 through a network interface 945. For example, computer system 900 may be coupled to a web server on the Internet such that a web browser executing on computer system 900 may interact with the web server as a user interacts with an interface that operates in the web browser. Computer system 900 may be able to access one or more remote storages 960 and one or more external components 965 through the network interface 945 and network 950.

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 900 may be used in conjunction with the invention. Moreover, one of ordinary skill in the art will appreciate that many other system configurations may also be used in conjunction with the invention or components of the invention.

Moreover, while the examples shown may illustrate many individual modules as separate elements, one of ordinary skill in the art would recognize that these modules may be combined into a single functional block or element. One of ordinary skill in the art would also recognize that a single module may be divided into multiple modules.

While the invention has been described with reference to numerous specific details, one of ordinary skill in the art will recognize that the invention may be embodied in other specific forms without departing from the spirit of the invention. For example, several embodiments were described above by reference to particular features and/or components. However, one of ordinary skill in the art will realize that other embodiments might be implemented with other types of features and components. One of ordinary skill in the art would understand that the invention is not to be limited by the foregoing illustrative details, but rather is to be defined by the appended claims.

We claim:

1. A scent storage element comprising:
a scent-retaining portion formed by at least one sealed section along an edge of the scent storage element;
a re-sealable feature along an edge of the scent-retaining portion; and
a tamper-proof element adapted to provide an indication as to whether the re-sealable feature has been opened after the tamper-proof element has been secured.

2. The scent storage element of claim 1 further comprising at least one label on an exterior surface of the scent-retaining portion.

3. The scent storage element of claim 2, wherein the at least one label comprises a plurality of entry regions, each region associated with a particular attribute.

4. The scent storage element of claim 1 further comprising a scent retention element adapted to collect a scent sample associated with a person and sized to fit within the scent-retaining portion.

5. The scent storage element of claim 1, wherein the tamper-proof element comprises:
a flap extending past the re-sealable feature;
an adhesive element that spans the flap; and
an adhesive cover that is adapted to prevent the adhesive element from being secured until the adhesive cover is removed from the adhesive element.

6. The scent storage element of claim 1, wherein the at least one sealed section along the edge of the scent storage element is formed by a heat seal.

7. The scent storage element of claim 1, wherein the re-sealable feature comprises a double-zipper type seal.

8. A scent collection and storage kit comprising:
a case;
a scent storage element;
a scent retention element adapted to fit within the scent storage element; and
usage instructions.

9. The scent collection and storage kit of claim 8, wherein the case comprises a tamper-proof feature.

10. The scent collection and storage kit of claim 9, wherein the tamper-proof feature comprises a unique identifying element.

11. The scent collection and storage kit of claim 8, wherein the case comprises:
a front portion;
a rear portion; and
at least one hinge coupling the front portion to the rear portion.

12. The scent collection and storage kit of claim 11, wherein the case further comprises:
a holding element adapted to secure the scent storage element, the scent retention element, and the usage instructions; and
a second holding element adapted to secure a data storage element.

13. The scent collection and storage kit of claim 8, wherein the usage instructions comprise graphical indications of a plurality of scent collection regions.

14. The scent collection and storage kit of claim 8 further comprising a set of odorless gloves.

15. A scent collection kit comprising:
a scent retention element; and
a scent storage element adapted to house the scent retention element.

16. The scent collection kit of claim 15, wherein the scent storage element comprises a tamper-proof feature.

17. The scent collection kit of claim 15, wherein the scent retention element comprises a gauze pad.

18. The scent collection kit of claim 15 further comprising a unique identifier associated with the scent collection kit.

19. The scent collection kit of claim 18, wherein the unique identifier comprises a serialized number.

20. The scent collection kit of claim 15, wherein the scent storage element comprises at least one exterior label including regions adapted to allow identifying information to be entered.
